(19) United States
(12) Patent Application Publication
(10) Pub. No.: US 2025/0014041 A1
(43) Pub. Date: Jan. 9, 2025

(54) CUSTOMIZED INTAKE HANDLING FOR FRAUDULENT AND/OR DISPUTED TRANSACTIONS

(71) Applicant: Capital One Services, LLC, McLean, VA (US)

(72) Inventors: Pawankumar PAWAR, Stone Ridge, VA (US); Elisabeth KAYTON, Charlotte, NC (US); Harvinder SINGH, Woodbridge, VA (US); Manikandan RAJARAM, Ashburn, VA (US)

(21) Appl. No.: 18/346,416

(22) Filed: Jul. 3, 2023

(51) Int. Cl. G06Q 20/40

(52) U.S. Cl. CPC G06Q 20/4016

(57) ABSTRACT

In some implementations, an intake system may receive, from a user device, a request to report a potential incident related to a transaction associated with a user account. The intake system may select an intake workflow to resolve the potential incident based on historical data associated with the user account and information associated with a user interface entry point used to report the potential incident. The intake system may present, to the user device, an initial screen, associated with the intake workflow, that includes one or more questions to request one or more user inputs that indicate one or more parameters related to the potential incident. The intake system may present, to the user device, a next screen associated with the intake workflow based on the historical data associated with the user account and the one or more user inputs that indicate the parameter(s) related to the potential incident.

### BACKGROUND

Transactions, such as credit card transactions, are associated with various risks, particularly in the form of fraud and disputes. For example, fraud may include unauthorized or deceitful activities that are carried out by individuals seeking to gain access to another party's identifying information or private data, which can occur through stolen account details, identity theft, and/or online hacking, among other examples. To combat fraud, institutions employ various security measures. Additionally, transaction participants may be advised to protect their information, regularly review transaction data, and report any suspicious transactions.

In contrast to fraud, disputed transactions may arise when a party believes that a recorded transaction is incorrect. Disputes can arise due to various reasons, such as errors, disputes between transaction parties, or non-receipt of goods or services. In such cases, parties may have the right to initiate a dispute resolution process. In the case of credit card transaction disputes, credit card issuers may investigate disputes and work toward a resolution.

### SUMMARY

Some implementations described herein relate to a system for customized intake handling. The system may include one or more memories and one or more processors communicatively coupled to the one or more memories. The one or more processors may be configured to receive, from a user device, a request to report a potential incident related to a transaction associated with a user account. The one or more processors may be configured to select an intake workflow to resolve the potential incident based on historical data associated with the user account and information associated with a user interface entry point used to report the potential incident. The one or more processors may be configured to present, to the user device, an initial screen associated with the intake workflow, wherein the initial screen associated with the intake workflow includes one or more questions to request one or more user inputs that indicate one or more parameters related to the potential incident. The one or more processors may be configured to present, to the user device, a next screen associated with the intake workflow, wherein the next screen is selected based on the historical data associated with the user account and the one or more user inputs that indicate the one or more parameters related to the potential incident.

Some implementations described herein relate to a method for customized intake handling. The method may include receiving, by an intake system and from a user device, a request to report a potential incident related to a transaction associated with a user account. The method may include selecting, by the intake system, an intake workflow to resolve the potential incident based on historical data associated with the user account and information associated with a user interface entry point used to report the potential incident. The method may include presenting, by the intake system and to the user device, an initial screen associated with the intake workflow, wherein the initial screen associated with the intake workflow includes one or more questions to request one or more user inputs that indicate one or more parameters related to the potential incident. The method may include presenting, by the intake system and to the user device, a next screen associated with the intake workflow, wherein the next screen is selected based on the historical data associated with the user account and the one or more user inputs that indicate the one or more parameters related to the potential incident. The method may include presenting, by the intake system and to the user device, a final screen associated with the intake workflow based on a determination that the one or more user inputs have resolved all required parameters associated with reporting the potential incident.

Some implementations described herein relate to a non-transitory computer-readable medium that stores a set of instructions. The set of instructions, when executed by one or more processors of an intake system, may cause the intake system to receive, from a user device, a request to report a potential incident related to a transaction associated with a user account. The set of instructions, when executed by one or more processors of the intake system, may cause the intake system to select an intake workflow to resolve the potential incident based on historical data associated with the user account and information associated with a user interface entry point used to report the potential incident. The set of instructions, when executed by one or more processors of the intake system, may cause the intake system to present, to the user device, an initial screen associated with the intake workflow, wherein the initial screen associated with the intake workflow includes one or more questions to request one or more user inputs that indicate one or more parameters related to the potential incident. The set of instructions, when executed by one or more processors of the intake system, may cause the intake system to present, to the user device, a next screen associated with the intake workflow, wherein the next screen is selected based on the historical data associated with the user account and the one or more user inputs that indicate the one or more parameters related to the potential incident, and wherein one or more of the intake workflow or the next screen associated with the intake workflow are selected using a machine learning model.

### BRIEF DESCRIPTION OF THE DRAWINGS

FIGS. 1A-1B are diagrams of an example implementation associated with customized intake handling for fraudulent and/or disputed transactions, in accordance with some embodiments of the present disclosure.

FIG. 2 is a diagram illustrating an example of training and using a machine learning model in connection with customized intake handling for fraudulent and/or disputed transactions, in accordance with some embodiments of the present disclosure.

FIG. 3 is a diagram of an example environment in which systems and/or methods described herein may be implemented, in accordance with some embodiments of the present disclosure.

FIG. 4 is a diagram of example components of one or more devices of FIG. 3, in accordance with some embodiments of the present disclosure.

FIG. 5 is a flowchart of an example process associated with customized intake handling for fraudulent and/or disputed transactions, in accordance with some embodiments of the present disclosure.

### DETAILED DESCRIPTION

The following detailed description of example implementations refers to the accompanying drawings. The same reference numbers in different drawings may identify the same or similar elements.

Consumer protections for fraudulent or disputed transactions are generally designed to safeguard individuals from bearing responsibility for unauthorized transactions and to provide avenues to resolve potential incidents related to fraudulent and/or disputed transactions. For example, many credit card issuers have limited liability policies that protect cardholders from fraudulent transactions (e.g., if a fraudulent transaction occurs, consumers are typically not held responsible for any unauthorized transactions, or liability may be limited to a maximum value). In addition, in cases where a consumer discovers an error or an unauthorized transaction on their credit card statement, the consumer can initiate a dispute resolution process to dispute (or challenge) the transaction. In such cases, an issuer will typically investigate the disputed transaction, and the transaction may be removed from the account of the user in cases where the issuer resolves the disputed transaction in favor of the customer. Additionally, or alternatively, a consumer may initiate a chargeback process in which a refund for a disputed transaction is requested directly from the issuer (e.g., rather than the merchant associated with the disputed transaction) for a fraudulent or otherwise unauthorized transaction, non-delivery of goods or services, and/or received damaged or defective items, among other examples. Furthermore, in various regions, laws or regulations may provide further consumer protections (e.g., the right to dispute billing errors, including unauthorized charges).

When a fraudulent transaction occurs or a consumer disputes a transaction, the issuer typically initiates a workflow to assist with investigating and resolving the fraudulent or disputed transaction. For example, a fraud workflow may include a detection step, where an issuer employs sophisticated fraud detection systems that monitor transactions in real-time to flag suspicious activities based on various factors (e.g., unusual patterns, high-value transactions, or geographical inconsistencies). When potential fraud is detected, the issuer may contact the user through automated notifications, email, text messages, or other communication channels to verify the transactions and/or otherwise confirm whether the transaction was authorized or indeed related to fraudulent activity. In cases where the user confirms that the activity was unauthorized and/or the issuer detects clear fraud indicators, the issuer will typically block further activity using the account to prevent further misuse, and the user is then advised to report the fraudulent transaction and initiate the resolution process. The issuer then initiates an investigation into the reported fraud, which may involve gathering additional information, analyzing transaction records, and/or collaborating with law enforcement agencies to the extent necessary before taking appropriate action to resolve the fraud (e.g., refunding unauthorized charges, removing the charges from the account of the cardholder, issuing a new credit card, and/or updating security measures) based on the findings of the investigation.

Although there may be some overlap between an incident in which a transaction is reported to be fraudulent and an incident in which a transaction is disputed, the workflow for resolving a disputed transaction differs in various respects from a workflow for resolving a claim of a fraudulent transaction. For example, in a typical workflow to resolve a disputed transaction, an account holder initially contacts their issuer when a transaction is believed to be incorrect or unauthorized, where the initial contact may be through a dedicated phone number, submitting an online dispute form, and/or via other suitable communication channels. The issuer may then require that the account holder provide relevant documentation to support the dispute, such as receipts, invoices, communication records with the merchant, and/or other suitable evidence that demonstrates the error or unauthorized transaction. The issuer then initiates an investigation into the disputed transaction, and may request additional information from the cardholder and/or communicate with the merchant to gather additional information related to the transaction. The issuer then determines the appropriate resolution based on the outcome of the investigation, where the resolution may include issuing a temporary credit to the account while the investigation is ongoing, reversing the charge, and/or facilitating mediation between the account holder and the merchant to reach a fair resolution. Throughout the process, the issuer typically keeps the account holder informed about the progress and the outcome of the dispute, and the account holder may escalate the dispute or seek further assistance from relevant consumer protection agencies if the account holder disagrees with the resolution.

In some cases, an issuer may develop and provide fraud and dispute workflows that are designed to provide users (e.g., account holders) with a customized experience based on data that is available to the issuer and/or inputs received from the users. Workflows may include particular intakes (“intake workflows”). An intake workflow may include, or may be based on, a particular incident, report, transaction, or the like. An incident may include an event, such as a disputed or incorrect transaction, a suspicious or fraudulent transaction, or a transaction flagged as one or more of these.

Classifying a particular incident as fraud or a dispute poses various challenges, because the resolution from a particular incident may be a finding that there is no fraud or dispute (e.g., the incident ends up being a non-issue), a dispute, a request to cancel a recurring purchase, an issue with a virtual card number (VCN), a hardship (e.g., difficulty paying), and/or fraud, among other examples. Furthermore, there may be various entry points into an intake workflow, and whether a particular incident relates to potential fraud or a dispute is not always clear from the entry point (e.g., the initial request to report a potential incident may arise because the account holder does not recognize or understand a transaction, because the account holder has a problem with the transaction and does not want to pay, and/or because the issuer notified the account holder to indicate that there is a problem with the account). Furthermore, issuers increasingly provide various channels that allow users to access their accounts and initiate intake workflows, including mobile applications, websites, and telephone call centers, among other examples. Accordingly, customization for fraud and dispute handling has traditionally been implemented on a channel-by-channel basis, with each communication channel having separate microservices or business logic (e.g., intake workflows that are designed for mobile applications may have separate user interfaces and business logic than intake workflows that are designed for web browsers and/or live agent systems).

As a result, in cases where customized workflows and supporting interfaces are developed channel-by-channel, underlying business logic may be arbitrarily unique to the associated channel, hardcoded and therefore not portable to other channels, and/or difficult to maintain. For example, channel-specific workflows may be reliant on integration with existing transaction processing systems, which may limit the frequency and agility of updating customized intake resolution workflows. In addition, developing customized workflows and supporting interfaces that are specific for a particular channel results in decreased flexibility and/or control (e.g., developers need to maintain entire intake workflows rather than individual screens or user interfaces, there is no opportunity for in-flow decision-making, and/or there are limited capabilities to monitor interactions that occur during an intake workflow).

Accordingly, in some implementations, an intake management system may provide customized intake handling for fraudulent and/or disputed transactions, which may be portable across different communication channels and provide capabilities to dynamically select an intake workflow and to dynamically select a next screen within the intake workflow to guide the user toward an appropriate resolution. For example, in some implementations, the intake system described herein may provide a backend for in-flow decision-making, where only user interface releases need to be updated to update an intake workflow for a new use case. Furthermore, the intake system described herein may include one or more application program interfaces (APIs) that provide capabilities to obtain information from one or more transaction backend systems, which allows frontend integration to occur with significant flexibility and agility. For example, at each decision-making point in an intake workflow, the intake system may check one or more rules to verify whether one or more tokens have been validated or need to be validated for a current screen of the intake workflow, may check one or more rules to determine whether one or more downstream API calls need to be made to obtain relevant transaction data from the integrated transaction backend systems, may invoke the appropriate API calls when needed, and may check one or more rules to return information indicating a next screen to be presented to a user and/or information to be presented on the next screen.

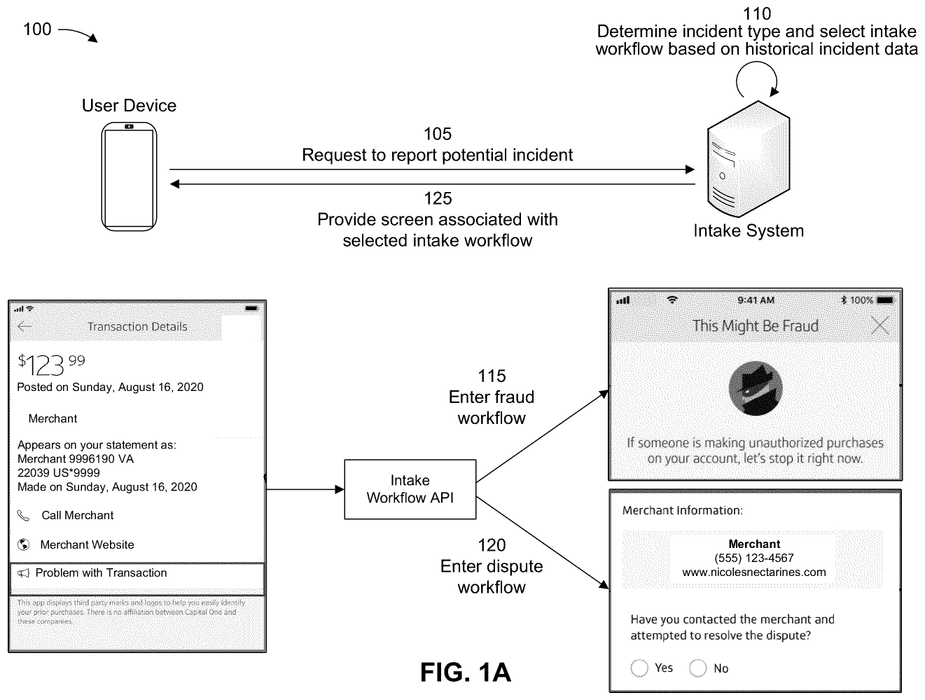

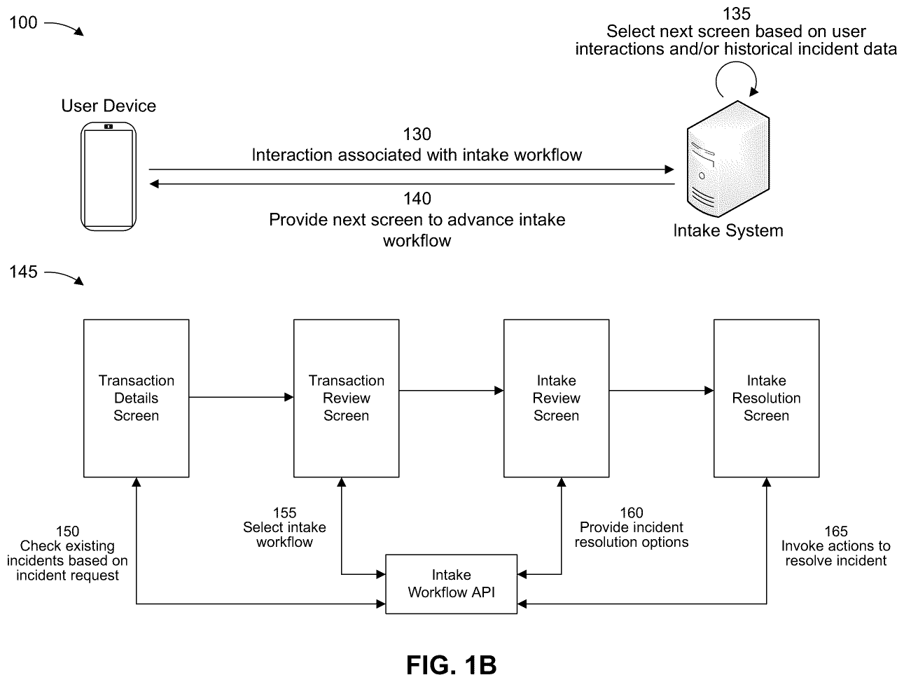

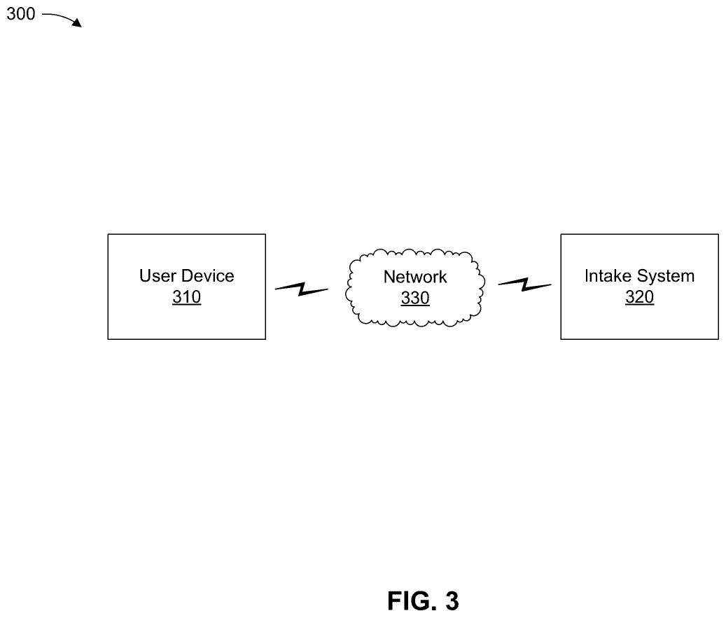

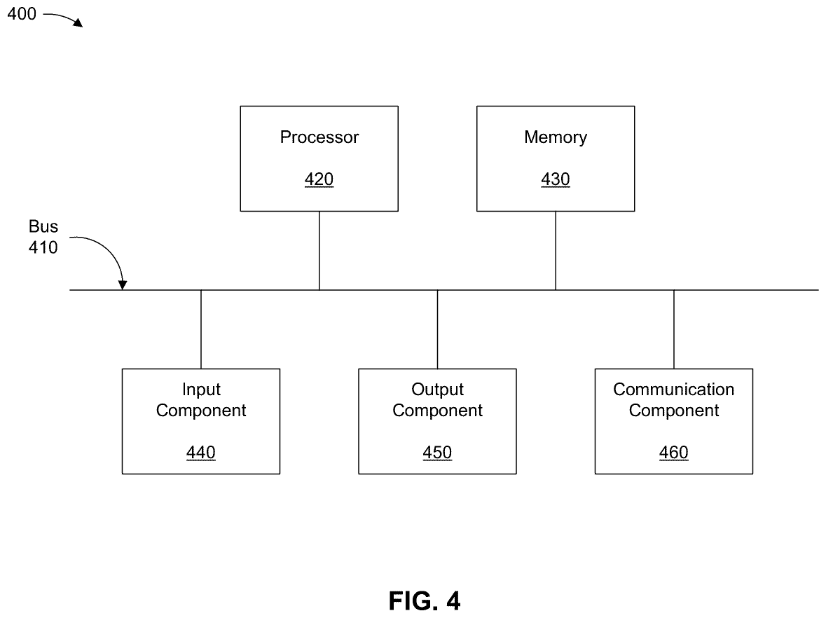

FIGS. 1A-1B are diagrams of an example 100 associated with customized intake handling for fraudulent and/or disputed transactions. As shown in FIGS. 1A-1B, example 100 includes a user device and an intake system. The user device and the intake system are described in more detail in connection with FIG. 3 and FIG. 4.

As shown in FIG. 1A, and by reference number 105, the user device may initiate, and the intake system may receive, a request to report a potential incident related to a transaction. For example, as described herein, the user device may be operated by a user that holds an account, which may be accessed via one or more communication channels. For example, in some implementations, the user device may access the account via a mobile application, a web browser, an interactive agent system, or another suitable channel. In some implementations, when the user device accesses the account, the corresponding channel may support one or more user interfaces to display information related to posted and/or pending transactions that have been charged to the account associated with the user, and the one or more user interfaces may include options to report a potential problem or incident with a transaction that may be fraudulent or disputed. Additionally, or alternatively, the intake system may actively monitor transactions that are charged to accounts to detect potentially unauthorized or suspicious activity, in which case one or more notifications may be sent to the user to alert the user about the potentially unauthorized or suspicious activity. For example, the one or more notifications may include mobile notifications, email messages, text messages, phone calls, or the like, which may prompt the user to access their account to resolve the potential incident. Accordingly, when the user device provides the request to report the potential incident with the transaction, the request may generally originate from an entry point that corresponds to a particular communication channel (e.g., mobile application, web browser, or the like), and to a particular user interface associated with the communication channel. For example, in some implementations, the user interface used to report the potential incident may correspond to a transaction details screen that indicates an amount, a merchant, a date, and/or other information associated with a transaction and provides an option to report a problem with the transaction. Additionally, or alternatively, the user interface used to report the potential incident may be associated with a customer service screen that includes options to report fraud, dispute a transaction, and/or view existing claims or disputes.

As further shown in FIG. 1A, and by reference number 110, the intake system may determine an incident type and select an appropriate intake workflow based on historical incident data associated with the user and/or other users and/or based on the entry point associated with the request to report the potential incident (e.g., the communication channel used to report the potential incident and/or the user interface screen or option used to report the potential incident). For example, in some implementations, prior to selecting an intake workflow to initiate a fraud or dispute resolution process associated with the reported incident, the intake system may perform one or more API calls to determine whether the user is eligible to report a fraud or dispute claim based on the historical data. For example, in some implementations, the intake system may perform one or more API calls to communicate with a transaction backend system to determine an age of the associated account, a date when an address associated with the account was last updated, a status (e.g., active, inactive, or expired) associated with the account, an issue date associated with the account, and/or a status related to whether there are any existing security reports or fraud cases associated with the account. Accordingly, in some implementations, the intake system may perform the one or more API calls to determine one or more of these and/or other parameters to verify that the user associated with the account is eligible to report a fraud claim or dispute a transaction. For example, in some implementations, the intake system may determine that the user is ineligible to report the potential incident if the account is less than a threshold number of days (e.g., thirty days) old, and/or if the address was changed within a threshold time period (e.g., the last thirty days). In addition, the intake system may obtain information indicating how frequently the user has historically reported fraudulent transactions or disputed transactions, information indicating whether the user has any existing fraud or dispute cases, information indicating whether the allegedly fraudulent or disputed transaction is a recurring transaction, and/or information indicating whether the allegedly fraudulent or disputed transaction is a transaction related to an alert that was sent to the user (e.g., based on suspicious activity indicative of potential fraud). Accordingly, the intake system may apply one or more rules and/or use a machine learning model to determine whether the user is eligible to report the incident based on the attributes described herein. In some implementations, in cases where the intake system determines that the user is ineligible to report the potential incident, the intake system may select a workflow that includes information to suggest that the user contact a customer service representative to discuss the potential incident and/or may provide an interface to indicate the reason why the incident is ineligible for reporting.

Additionally, or alternatively, in cases where the intake system determines that the user is eligible to report the potential incident, the intake system may select an appropriate workflow to resolve the incident based on the historical data associated with the user, historical data associated with other users, and/or the entry point that was used to report the potential incident. For example, when the user reports the incident, the intake system may perform one or more API calls to determine whether the user has a purchase history with the associated merchant, whether the transaction is a recurring transaction, and/or other suitable information that may relate to purchasing patterns, user activity patterns, and/or other patterns that may indicate whether the potential incident is likely to be a fraud claim or to be a dispute. In some implementations, the intake system may apply one or more rules and/or may use a machine learning model to determine a first probability of the incident being a fraud claim and a second probability of the incident being a dispute, and may select the corresponding workflow in cases where the first and/or second probability indicates fraud or dispute, respectively, with a confidence level that satisfies a threshold. FIG. 1A depicts an example where a user selects an option on a transaction details screen to report a problem with a transaction, which invokes an intake workflow API to classify the request as a fraud claim or a dispute claim. For example, when the intake workflow API is called, the intake system may perform a first check to determine whether token verification is needed (e.g., to verify that a current screen is included among one or more acceptable screens for the current stage in the incident report to prevent users from improperly hacking into the intake system), and may check one or more attributes that may indicate whether the incident should be classified as fraud or a dispute. For example, in some implementations, the attributes may include indicators of whether the account was charged more than once, whether the user is being charged for goods or services that were cancelled or returned, whether the user did not receive goods or services that were paid for, whether the user paid for the goods or services using another payment method, and/or whether received goods or services were damaged or defective. In some implementations, the intake system may determine whether the attributes relevant to classifying the incident are available, and may perform one or more API calls to retrieve the attributes from another system where such data may be available. Additionally, or alternatively, the intake system may select a workflow with an initial screen that includes one or more questions to solicit feedback from the user that indicates the appropriate attributes.

In some implementations, in addition to the attributes related to the transaction and the historical data associated with the user and/or other users, the intake system may evaluate the entry point of the incident request to select the appropriate workflow (e.g., fraud or dispute). For example, in cases where the user initiates an incident report through an interface associated with requesting a replacement card, the intake system may obtain one or more parameters that indicate whether the user is requesting the replacement card to obtain a new card with added security features (e.g., contactless payment) or because a current card was lost, in which case the intake system may select a workflow that includes questions related to whether a new credit card number is needed, a new card is needed, and/or whether any unauthorized activity has been observed. Additionally, or alternatively, the incident request may originate from an interface that is used to report a problem with a transaction, which may result in the intake system selecting a workflow to dynamically guide the user through a series of prompts to differentiate fraud from dispute claims. Accordingly, as shown by reference number 115, the intake system may enter a fraud workflow based on the historical data and/or the entry point of the request indicating that the probability of the incident being fraud satisfies a threshold. Additionally, or alternatively, as shown by reference number 120, the intake system may enter a dispute workflow based on the historical data and/or the entry point of the request indicating that the probability of the incident being a dispute satisfies a threshold. Additionally, or alternatively, in cases where the probability of the incident being fraud or a dispute cannot be determined with a confidence that satisfies a threshold, the intake system may initiate a workflow that includes one or more questions to obtain more information that may be used to determine the incident type.

As further shown in FIG. 1A, and by reference number 125, the intake system may then present, to the user device, an initial screen associated with the selected intake workflow, where the initial screen may include one or more probing questions to dynamically investigate the potential incident. For example, the one or more questions may be designed to investigate variables such as whether the user recognizes the transaction, whether the user has contacted the merchant directly, whether the user has ever given the merchant their account information, whether the transaction was for merchandise or services, whether the subject of the transaction was received, and/or whether the user attempted to cancel the transaction, among other examples. Accordingly, as described herein, the initial screen of the selected intake workflow may be selected based on various data attributes and/or business rules to intelligently and dynamically guide the user through the workflow. For example, as described herein, each decision that the intake system generates at any stage of an intake resolution workflow may be based on historical data obtained via one or more API calls, responses that the user has provided to questions that were presented during the workflow, data from one or more requests received from the user device (e.g., data related to the entry point of the incident report), and/or outputs from one or more machine learning models (e.g., that are trained to determine eligibility to report an incident, classify an incident into a fraud or dispute type, and/or select a next screen of the workflow), among other examples. Accordingly, in some implementations, the intake workflow API may be called at any suitable decision-making point in the workflow to select a next screen that dynamically guides the user toward a resolution of the incident.

For example, as shown in FIG. 1B, the user device may provide, and the intake system may receive, one or more interactions associated with the intake workflow, where the one or more interactions may include user inputs such as responses to questions that are presented on one or more screens of the intake workflow and/or selection of one or more options that are presented on one or more screens of the intake workflow. In general, as shown by reference number 135, the intake system may select a next screen of the intake workflow each time that the intake workflow reaches a decision-making point (e.g., where the workflow may branch to a fraud workflow or a dispute workflow, or to arrive at a particular outcome, such as a damaged card outcome, a lost card outcome, a dispute outcome, or the like). For example, one or more screens of the intake workflow may include an informational message that may inform the user about what to expect while the incident is investigated and/or indicate one or more next steps in resolving the potential incident. Additionally, or alternatively, one or more screens of the intake workflow may include instructional messages that indicate actions to be performed by the user, such as contacting the merchant, calling a customer service agent, and/or providing documentation to support the fraud or dispute. Additionally, or alternatively, one or more screens of the intake workflow may be responsive to inputs that the user provides during the intake workflow, and may include questions to dynamically guide the user toward an appropriate resolution. Accordingly, when the intake system selects the next screen of the intake workflow, the intake system may perform one or more checks (e.g., using lookup tables or a machine learning model) to determine the next screen to advance the workflow.

For example, each time that the current intake workflow reaches a decision-making point where the intake system is to select a next screen, the intake system may determine one or more parameters relevant to the current screen and may determine whether such parameters are available. In some implementations, in cases where all of the parameters are available, the intake system may then map the parameters to the appropriate next screen in the workflow.

Alternatively, in cases where one or more parameters are unavailable, the intake system may perform one or more API calls to obtain the parameters from an integrated transaction backend system or the like, and may then map the parameters to the appropriate next screen in the workflow if the parameters are able to be obtained through the one or more API calls. Alternatively, in cases where one or more parameters are unavailable and cannot be obtained through the one or more API calls, the intake system may select a next screen that includes one or more questions to obtain the necessary parameters. Accordingly, as shown by reference number 145, the intake system may then provide the next screen that is selected based on the parameters described herein to advance the intake workflow, until the interactions with the user device reach a final outcome. The final screen of the intake workflow may then indicate that the parameters needed to initiate investigation and/or resolution of the incident have been obtained by the intake system, and may provide information and/or instructions regarding the next steps to resolve the reported incident.

For example, referring to FIG. 1B, reference number 145 depicts a series of screens associated with reporting a potential incident with a transaction and dynamically guiding the user through a series of screens to obtain the information needed to resolve the reported incident. For example, in FIG. 1B, the user enters the intake workflow through a transaction details screen, which may include information such as an amount, a posting date, a merchant name, a merchant address, a website link, and/or an option to report or request help with a transaction. As shown by reference number 150, in cases where the user selects the option to report or request help with the transaction, the intake system may perform one or more API calls (e.g., to check for existing claims and/or other relevant data) to determine whether the user is eligible to report the incident. In some implementations, in cases where the user is determined to be eligible to report the incident, the intake system may present a transaction review screen to the user to solicit more information about the transaction. For example, in some implementations, the transaction review screen may include questions to assess whether the user recognizes the transaction, whether the user ever gave the merchant their account information, and/or whether the user received what was purchased, among other examples. In some implementations, as shown by reference number 155, the intake system may use answers that the user provides on the transaction review screen(s) to classify the incident as fraud or a dispute. Additionally, or alternatively, the intake system may classify the incident as fraud or a dispute without presenting any screens that include questions for the user when the historical data and/or entry point can be used to classify the incident with a high degree of confidence.

As further shown in FIG. 1B, the intake system may then present an incident review screen to the user device. Furthermore, as shown by reference number 160, the intake system may perform one or more API calls to determine one or more incident resolution options to be indicated via the incident review screen. For example, the incident resolution options may include a suggestion to contact the merchant and/or an instruction to destroy an existing physical transaction device, among other examples. Additionally, or alternatively, the incident review screen may include information to set expectations regarding how the incident will be investigated and resolved. For example, in some implementations, the incident review screen may indicate the amount of time that the merchant has to respond to a fraud or dispute claim, an amount of time until the user can expect to see a temporary credit or chargeback, and/or a date when a new or replacement transaction device will arrive, among other examples. As further shown in FIG. 1B, the next screen in the intake workflow may then correspond to an incident resolution screen, and the intake system may perform one or more API calls to invoke actions to resolve the incident. For example, for a fraud claim, the actions may include invalidating an existing account number, issuing a replacement transaction device, and/or providing the user with an option to update their account information with one or more merchants where the user has recurring transactions, among other examples. In another example, for a dispute claim, the actions may include sending messages to the merchant, sending an email message to the user with details related to the dispute case, and/or providing options to submit documentation to support the dispute claim.

Accordingly, as described herein, the intake system may provide a dynamic and flexible approach to reporting and resolving transaction incidents that relate to potentially fraudulent transactions and/or disputed transactions. For example, when an incident is first reported, the intake system may use various data sources (e.g., historical data, machine learning outputs, or the like) to determine whether to classify the incident as fraud or a dispute and/or to select an initial screen that includes questions to aid in classifying the incident as fraud or a dispute. Furthermore, as described herein, the intake system may use user answers or responses that are provided during the intake workflow in combination with the historical data, machine learning outputs, or the like to select a next screen at each decision-making point in the intake workflow. In this way, the intake workflow is not bound to any particular sequence of screens or user interfaces, and is dynamically customized to guide the user toward the appropriate resolution. Furthermore, the various screens associated with the intake workflow may be operable with any suitable communication channel, which allows the user to start the incident report in a first communication channel and switch to another channel if needed. For example, in some implementations, the user device may report the potential incident via a mobile application, and during the intake workflow the user of the user device may select an option to switch the workflow to a web browser or an interactive agent system. In this way, the intake system offers significant flexibility, and a capability to obtain relevant parameters to resolve fraud or dispute claims via API calls to other integrated systems.

As indicated above, FIGS. 1A-1B are provided as an example. Other examples may differ from what is described with regard to FIGS. 1A-1B.

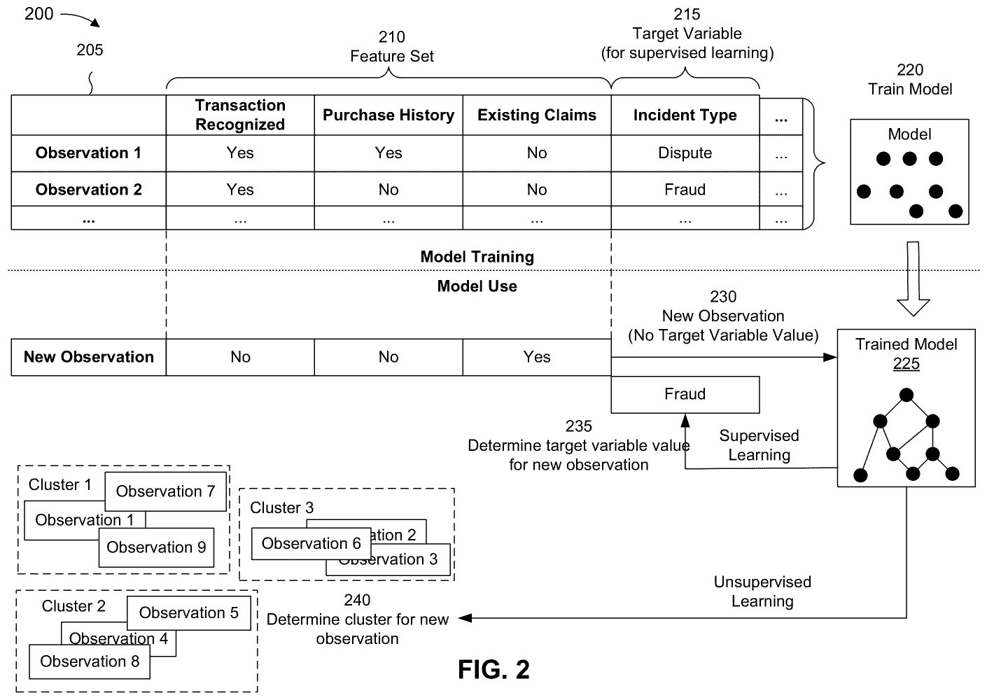

FIG. 2 is a diagram illustrating an example 200 of training and using a machine learning model in connection with customized intake handling for fraudulent and/or disputed transactions, in accordance with some embodiments of the present disclosure. The machine learning model training and usage described herein may be performed using a machine learning system. The machine learning system may include or may be included in a computing device, a server, a cloud computing environment, or the like, such as the intake system described in more detail elsewhere herein.

As shown by reference number 205, a machine learning model may be trained using a set of observations. The set of observations may be obtained from training data (e.g., historical data), such as data gathered during one or more processes described herein. In some implementations, the machine learning system may receive the set of observations (e.g., as input) from the intake system, a transaction backend system, a transaction data repository, and/or another suitable data source, as described elsewhere herein.

As shown by reference number 210, the set of observations may include a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the intake system, a transaction backend system, a transaction data repository, and/or another suitable data source. For example, the machine learning system may identify a feature set (e.g., one or more features and/or feature values) by extracting the feature set from structured data, by performing natural language processing to extract the feature set from unstructured data, and/or by receiving input from an operator.

As an example, a feature set for a set of observations may include a first feature of transaction recognized, a second feature of purchase history, a third feature of existing claims, and so on. As shown, for a first observation, the first feature may have a value of Yes (e.g., indicating that a user reporting a potential incident associated with a transaction recognizes the transaction), the second feature may have a value of Yes (e.g., indicating that the user reporting the potential incident associated with the transaction has a purchase history with the merchant associated with the transaction), the third feature may have a value of No (e.g., indicating that a user does not have any current fraud or dispute claims that are pending resolution), and so on. These features and feature values are provided as examples, and may differ in other examples. For example, the feature set may include one or more of the following features: recurring indicator, order links, merchant contacted, and/or purchase type, among other examples.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiples classes, classifications, or labels) and/or may represent a variable having a Boolean value. A target variable may be associated with a target variable value, and a target variable value may be specific to an observation. In example 200, the target variable is incident type, which has a value of dispute for the first observation.

The feature set and target variable described above are provided as examples, and other examples may differ from what is described above. For example, for a target variable of next screen, the feature set may include a current screen feature, one or more question features (e.g., questions presented on the current screen), one or more answer or response features (e.g., answers or responses to the questions on the current screen), or the like.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, or the like. After training, the machine learning system may store the machine learning model as a trained machine learning model 225 to be used to analyze new observations.

As an example, the machine learning system may obtain training data for the set of observations based on historical fraud and/or dispute claims, including screens that were presented to consumers during workflows to resolve the fraud and/or dispute claims, questions that were presented to consumers during the workflows to resolve the fraud and/or dispute claims, answers that the consumers provided during the workflows to resolve the fraud and/or dispute claims, and/or various data points related to the fraudulent and/or disputed transactions (e.g., whether customers had purchase histories with the associated merchants, whether any details of the fraudulent or disputed transactions were recognized, or the like).

As shown by reference number 230, the machine learning system may apply the trained machine learning model 225 to a new observation, such as by receiving a new observation and inputting the new observation to the trained machine learning model 225. As shown, the new observation may include a first feature of No (e.g., indicating that a transaction associated with a reported incident is not recognized), a second feature of No (e.g., indicating that the user reporting the incident does not have a purchase history with the merchant associated with the transaction), a third feature of Yes (e.g., indicating that the consumer has existing fraud and/or dispute claims that are pending resolution), and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs and/or information that indicates a degree of similarity between the new observation and one or more other observations, such as when unsupervised learning is employed.

As an example, the trained machine learning model 225 may predict a value of Fraud for the target variable of incident type for the new observation, as shown by reference number 235. Based on this prediction, the machine learning system may provide a first recommendation, may provide output for determination of a first recommendation, may perform a first automated action, and/or may cause a first automated action to be performed (e.g., by instructing another device to perform the automated action), among other examples. The first recommendation may include, for example, a recommendation to freeze or block further activity using the associated account to prevent additional fraudulent transactions. The first automated action may include, for example, invaliding an account number that was used to perform the potentially fraudulent transaction and/or issuing a new transaction device to the user and/or triggering a fraud workflow to dynamically guide the user through resolution of the potential fraud incident.

As another example, if the machine learning system were to predict a value of Dispute for the target variable of incident type, then the machine learning system may provide a second (e.g., different) recommendation (e.g., recommending that the user contact the merchant to resolve the dispute) and/or may perform or cause performance of a second (e.g., different) automated action (e.g., sending a message to the user to request additional documentation related to the disputed transaction and/or sending a message to the merchant to gather additional details related to the disputed transaction and/or facilitate mediation between the user and the merchant).

In some implementations, the trained machine learning model 225 may classify (e.g., cluster) the new observation in a cluster, as shown by reference number 240. The observations within a cluster may have a threshold degree of similarity. As an example, if the machine learning system classifies the new observation in a first cluster (e.g., fraud incidents), then the machine learning system may provide a first recommendation, such as the first recommendation described above. Additionally, or alternatively, the machine learning system may perform a first automated action and/or may cause a first automated action to be performed (e.g., by instructing another device to perform the automated action) based on classifying the new observation in the first cluster, such as the first automated action described above.

As another example, if the machine learning system were to classify the new observation in a second cluster (e.g., dispute incidents), then the machine learning system may provide a second (e.g., different) recommendation, such as the second recommendation described above, and/or may perform or cause performance of a second (e.g., different) automated action, such as the second automated action described above.

In some implementations, the recommendation and/or the automated action associated with the new observation may be based on a target variable value having a particular label (e.g., classification or categorization), may be based on whether a target variable value satisfies one or more threshold (e.g., whether the target variable value is greater than a threshold, is less than a threshold, is equal to a threshold, falls within a range of threshold values, or the like), and/or may be based on a cluster in which the new observation is classified.

In some implementations, the trained machine learning model 225 may be re-trained using feedback information. For example, feedback may be provided to the machine learning model. The feedback may be associated with actions performed based on the recommendations provided by the trained machine learning model 225 and/or automated actions performed, or caused, by the trained machine learning model 225. In other words, the recommendations and/or actions output by the trained machine learning model 225 may be used as inputs to re-train the machine learning model (e.g., a feedback loop may be used to train and/or update the machine learning model). For example, the feedback information may include information that is obtained or otherwise gathered via a fraud or dispute workflow that is triggered to resolve an incident in which a user reports a potentially fraudulent transaction or a disputed transaction.

In this way, the machine learning system may apply a rigorous and automated process to select an appropriate intake workflow and/or a next screen to be presented to a user device during a current intake workflow. The machine learning system may enable recognition and/or identification of tens, hundreds, thousands, or millions of features and/or feature values for tens, hundreds, thousands, or millions of observations, thereby increasing accuracy and consistency and reducing delay associated with selecting an appropriate intake workflow and/or a next screen to be presented to a user device during a current intake workflow relative to requiring computing resources to be allocated for tens, hundreds, or thousands of operators to manually select an appropriate intake workflow and/or a next screen to be presented to a user device during a current intake workflow using the features or feature values.

As indicated above, FIG. 2 is provided as an example. Other examples may differ from what is described in connection with FIG. 2.

FIG. 3 is a diagram of an example environment 300 in which systems and/or methods described herein may be implemented. As shown in FIG. 3, environment 300 may include a user device 310, an intake system 320, and a network 330. Devices of environment 300 may interconnect via wired connections, wireless connections, or a combination of wired and wireless connections.

The user device 310 may include one or more devices capable of receiving, generating, storing, processing, and/or providing information associated with customized intake handling for fraudulent and/or disputed transactions, as described elsewhere herein. The user device 310 may include a communication device and/or a computing device. For example, the user device 310 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The intake system 320 may include one or more devices capable of receiving, generating, storing, processing, providing, and/or routing information associated with customized intake handling for fraudulent and/or disputed transactions, as described elsewhere herein, as described elsewhere herein. The intake system 320 may include a communication device and/or a computing device. For example, the intake system 320 may include a server, such as an application server, a client server, a web server, a database server, a host server, a proxy server, a virtual server (e.g., executing on computing hardware), or a server in a cloud computing system. In some implementations, the intake system 320 may include computing hardware used in a cloud computing environment.

The network 330 may include one or more wired and/or wireless networks. For example, the network 330 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 330 enables communication among the devices of environment 300.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of environment 300 may perform one or more functions described as being performed by another set of devices of environment 300.

FIG. 4 is a diagram of example components of a device 400 associated with customized intake handling for fraudulent and/or disputed transactions. The device 400 may correspond to the user device 310 and/or the intake system 320. In some implementations, the user device 310 and/or the intake system 320 may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

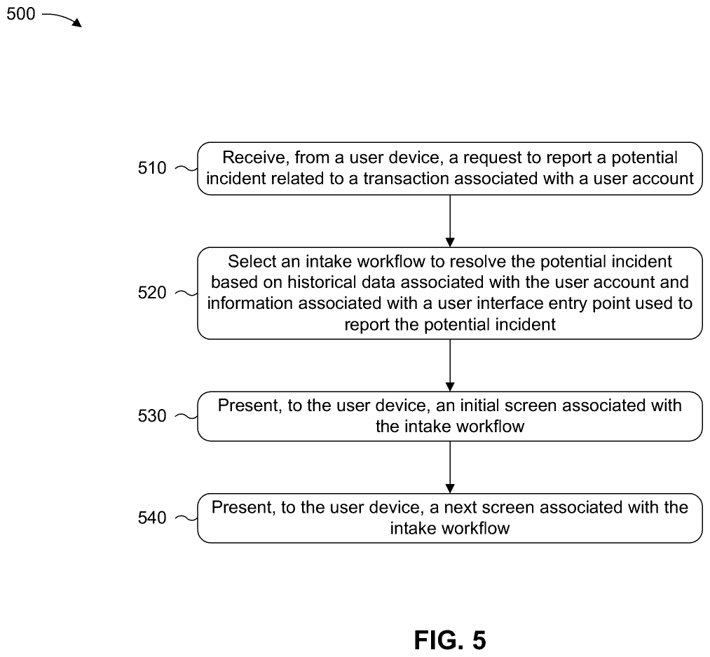

FIG. 5 is a flowchart of an example process 500 associated with customized intake handling for fraudulent and/or disputed transactions. In some implementations, one or more process blocks of FIG. 5 may be performed by the intake system 320. In some implementations, one or more process blocks of FIG. 5 may be performed by another device or a group of devices separate from or including the intake system 320, such as the user device 310. Additionally, or alternatively, one or more process blocks of FIG. 5 may be performed by one or more components of the device 400, such as processor 420, memory 430, input component 440, output component 450, and/or communication component 460.

As shown in FIG. 5, process 500 may include receiving, from a user device, a request to report a potential incident related to a transaction associated with a user account (block 510). For example, the intake system 320 (e.g., using processor 420, memory 430, input component 440, and/or communication component 460) may receive, from a user device, a request to report a potential incident related to a transaction associated with a user account, as described above in connection with reference number 105 of FIG. 1A. As an example, a user may access an account via a mobile application, a web application, or another suitable channel, and may initiate a request to report a potential incident when one or more transactions associated with the account appear to be fraudulent (e.g., because the user did not authorize the one or more transactions) and/or when one or more transactions associated with the account are disputed (e.g., because the user did not receive goods or services and/or there is a billing error associated with the one or more transactions, among other examples).

As further shown in FIG. 5, process 500 may include selecting an intake workflow to resolve the potential incident based on historical data associated with the user account and information associated with a user interface entry point used to report the potential incident (block 520). For example, the intake system 320 (e.g., using processor 420 and/or memory 430) may select an intake workflow to resolve the potential incident based on historical data associated with the user account and information associated with a user interface entry point used to report the potential incident, as described above in connection with reference numbers 110, 115, and 120 of FIG. 1A. As an example, the intake system may evaluate historical data such as recurring transactions associated with the user account, a purchase history associated with the use account, one or more order links associated with the user account, and/or a history of existing fraud and/or dispute claims associated with the user account, and the intake system may select an appropriate intake workflow (e.g., a fraud workflow or a dispute workflow) based on the historical data. Furthermore, in some implementations, the intake system may determine an entry point associated with the request to report the potential incident (e.g., a user interface that was used to initiate the request to report the potential incident), which the intake system may use to select the appropriate workflow (e.g., using a fraud workflow or a dispute workflow that includes user interfaces tailored to a mobile application, a web browser, or another suitable channel depending on the entry point used to report the potential incident).

As further shown in FIG. 5, process 500 may include presenting, to the user device, an initial screen associated with the intake workflow, wherein the initial screen associated with the intake workflow includes one or more questions to request one or more user inputs that indicate one or more parameters related to the potential incident (block 530). For example, the intake system 320 (e.g., using processor 420, memory 430, and/or output component 450) may present, to the user device, an initial screen associated with the intake workflow, wherein the initial screen associated with the intake workflow includes one or more questions to request one or more user inputs that indicate one or more parameters related to the potential incident, as described above in connection with reference number 125 of FIG. 1A. As an example, the initial screen that is presented to the user device may include various questions that allow the user to indicate details related to the potential incident, such as whether the potential incident relates to a transaction that was charged to the user account multiple times, a transaction that was charged for an order that was returned or cancelled, a transaction that is associated with an incorrect amount, and/or a transaction that is not recognized, among other examples.

As further shown in FIG. 5, process 500 may include presenting, to the user device, a next screen associated with the intake workflow, wherein the next screen is selected based on the historical data associated with the user account and the one or more user inputs that indicate the one or more parameters related to the potential incident (block 540). For example, the 3 (e.g., using processor 420, memory 430, and/or output component 450) may present, to the user device, a next screen associated with the intake workflow, wherein the next screen is selected based on the historical data associated with the user account and the one or more user inputs that indicate the one or more parameters related to the potential incident, as described above in connection with reference numbers 135 and 140 of FIG. 1B. As an example, based on the information presented on the initial screen, the intake system may determine whether one or more tokens need to be verified for the initial screen (e.g., whether certain information needs to be verified to allow the intake workflow to progress to a next screen), may determine whether one or more APIs need to be called in order to obtain one or more attributes to be processed on the initial screen, and may select a next screen to be presented to the user when all appropriate tokens have been verified and all the attributes to be processed have been obtained (e.g., after performing one or more API calls). For example, the next screen may be selected to be responsive to the answers that the user provided on the initial (or previous) screen, and may be selected to dynamically guide the user toward a resolution of the incident based on API data and the answers that the user provided on the initial (or previous) screen.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIGS. 1A-1B. Moreover, while the process 500 has been described in relation to the devices and components of the preceding figures, the process 500 can be performed using alternative, additional, or fewer devices and/or components. Thus, the process 500 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for customized intake handling, the system comprising:
one or more memories; and
one or more processors, communicatively coupled to the one or more memories, configured to:
receive, from a user device, a request to report a potential incident related to a transaction associated with a user account;
select an intake workflow to resolve the potential incident based on historical data associated with the user account and information associated with a user interface entry point used to report the potential incident;
present, to the user device, an initial screen associated with the intake workflow,
wherein the initial screen associated with the intake workflow includes one or more questions to request one or more user inputs that indicate one or more parameters related to the potential incident; and
present, to the user device, a next screen associated with the intake workflow,
wherein the next screen is selected based on the historical data associated with the user account and the one or more user inputs that indicate the one or more parameters related to the potential incident.

2. The system of claim 1, wherein the intake workflow is associated with a fraud claim type or a dispute claim type based on the historical data associated with the user account and the information associated with a user interface entry point used to report the potential incident.

3. The system of claim 1, wherein the next screen associated with the intake workflow includes a reactive message that is responsive to the one or more user inputs and provides guidance related to reporting the potential incident.

4. The system of claim 1, wherein the one or more processors are configured to present the initial screen associated with the intake workflow to the user device based on a determination that the user account is eligible to report the potential incident,
wherein eligibility to report the potential incident is based on one or more of an incident reporting history associated with the user account, existing incident reports associated with the user account, a recurring or non-recurring status associated with the transaction, or an alert status associated with the transaction.

5. The system of claim 1, wherein the one or more processors are further configured to:
present, to the user device, a final screen associated with the intake workflow based on a determination that the one or more user inputs have resolved all required parameters associated with reporting the potential incident,
wherein the final screen includes an informational message that indicates one or more next steps in resolving the potential incident or an instructional message that indicates one or more directions for resolving the potential incident.

6. The system of claim 1, wherein one or more of the intake workflow or the next screen associated with the intake workflow are selected using a machine learning model.

7. The system of claim 1, wherein the user interface entry point is associated with a first user interface channel, and wherein one or more of the initial screen or the next screen of the intake workflow is associated with a second user interface channel.

8. A method for customized intake handling, comprising:
receiving, by an intake system and from a user device, a request to report a potential incident related to a transaction associated with a user account;
selecting, by the intake system, an intake workflow to resolve the potential incident based on historical data associated with the user account and information associated with a user interface entry point used to report the potential incident;
presenting, by the intake system and to the user device, an initial screen associated with the intake workflow,
wherein the initial screen associated with the intake workflow includes one or more questions to request one or more user inputs that indicate one or more parameters related to the potential incident;
presenting, by the intake system and to the user device, a next screen associated with the intake workflow,
wherein the next screen is selected based on the historical data associated with the user account and the one or more user inputs that indicate the one or more parameters related to the potential incident; and
presenting, by the intake system and to the user device, a final screen associated with the intake workflow based on a determination that the one or more user inputs have resolved all required parameters associated with reporting the potential incident.

9. The method of claim 8, wherein the intake workflow is associated with a fraud claim type or a dispute claim type based on the historical data associated with the user account and the information associated with a user interface entry point used to report the potential incident.

10. The method of claim 8, wherein the next screen associated with the intake workflow includes a reactive message that is responsive to the one or more user inputs and provides guidance related to reporting the potential incident.

11. The method of claim 8, further comprising:
presenting the initial screen associated with the intake workflow to the user device based on a determination that the user account is eligible to report the potential incident,
wherein eligibility to report the potential incident is based on one or more of an incident reporting history associated with the user account, existing incident reports associated with the user account, a recurring or non-recurring status associated with the transaction, or an alert status associated with the transaction.

12. The method of claim 8, wherein the final screen includes an informational message that indicates one or more next steps in resolving the potential incident or an instructional message that indicates one or more directions for resolving the potential incident.

13. The method of claim 8, wherein one or more of the intake workflow or the next screen associated with the intake workflow are selected using a machine learning model.

14. The method of claim 8, wherein the user interface entry point is associated with a first user interface channel, and wherein one or more of the initial screen or the next screen of the intake workflow is associated with a second user interface channel.

15. A non-transitory computer-readable medium storing a set of instructions, the set of instructions comprising:
one or more instructions that, when executed by one or more processors of an intake system, cause the intake system to:
receive, from a user device, a request to report a potential incident related to a transaction associated with a user account;
select an intake workflow to resolve the potential incident based on historical data associated with the user account and information associated with a user interface entry point used to report the potential incident;
present, to the user device, an initial screen associated with the intake workflow,
wherein the initial screen associated with the incident workflow includes one or more questions to request one or more user inputs that indicate one or more parameters related to the potential incident; and
present, to the user device, a next screen associated with the intake workflow,
wherein the next screen is selected based on the historical data associated with the user account and the one or more user inputs that indicate the one or more parameters related to the potential incident, and
wherein one or more of the intake workflow or the next screen associated with the intake workflow are selected using a machine learning model.

16. The non-transitory computer-readable medium of claim 15, wherein the intake workflow is associated with a fraud claim type or a dispute claim type based on the historical data associated with the user account and the information associated with a user interface entry point used to report the potential incident.

17. The non-transitory computer-readable medium of claim 15, wherein the next screen associated with the intake workflow includes a reactive message that is responsive to the one or more user inputs and provides guidance related to reporting the potential incident.

18. The non-transitory computer-readable medium of claim 15, wherein the one or more instructions further cause the intake system to present the initial screen associated with the intake workflow to the user device based on a determination that the user account is eligible to report the potential incident,
wherein eligibility to report the potential incident is based on one or more of an incident reporting history associated with the user account, existing incident reports associated with the user account, a recurring or non-recurring status associated with the transaction, or an alert status associated with the transaction.

19. The non-transitory computer-readable medium of claim 15, wherein the one or more instructions further cause the intake system to:
present, to the user device, a final screen associated with the intake workflow based on a determination that the one or more user inputs have resolved all required parameters associated with reporting the potential incident,
wherein the final screen includes an informational message that indicates one or more next steps in resolving the potential incident or an instructional message that indicates one or more directions for resolving the potential incident.

20. The non-transitory computer-readable medium of claim 15, wherein the user interface entry point is associated with a first user interface channel, and wherein one or more of the initial screen or the next screen of the intake workflow is associated with a second user interface channel.
